(19) United States
(12) Patent Application Publication
(10) Pub. No.: US 2026/0033667 A1
(43) Pub. Date: Feb. 5, 2026

(54) Non-Fluorinated Single-Layer Coating Based On Silicone Resin And Thermoplastic Polymer

(71) Applicant: SEB S.A., Ecully (FR)

(72) Inventors: Barbara Gantillon, Ecully Cedex (FR); Stéphanie Le Bris, Ecully Cedex (FR); Perrine Tanguy, Ecully Cedex (FR)

(73) Assignee: SEB. S.A., Ecully (FR)

(21) Appl. No.: 18/998,351

(22) PCT Filed: Jul. 28, 2023
(86) PCT No.: PCT/FR2023/051205

§ 371 Date: Jan. 24, 2025

(30) Foreign Application Priority Data
Jul. 29, 2022 (FR) FR2207890

(51) Int. Cl. A47J 36/02; B05D 5/08; C09D 7/61; C09D 183/04

(52) U.S. Cl. CPC A47J 36/025; B05D 5/08; C09D 7/61; C09D 183/04; B05D 2202/25

(57) ABSTRACT

A coated cooking element for a kitchen utensil or electrical cooking appliance includes a metal substrate coated, on at least one face, with a single layer which, by one of its faces, is in contact with the metal substrate and one of the faces of which forms a cooking face. The layer includes one or more silicone resins, one or more heterocyclic thermoplastic polymers selected from the group consisting of polyetherimides, polyimides), polyamide imides, and polybenzymidazole, and optionally one or more aromatic thermoplastic polymers, one or more fillers and/or one or more additives and/or one or more coloring agents; a process for manufacturing same, a kitchen utensil or an electrical cooking appliance including same.

The field of the invention is that of culinary items coated on one of their faces with a coating and more precisely, silicone resin-based coatings of these items.

In the field of culinary items, coatings based on fluoropolymers and in particular polytetrafluoroethylene (PTFE) are known to the general public for their non-stick and temperature resistance properties.

However, these coatings have a low mechanical strength.

Application WO 2020/144051 concerns a coating based on fluoropolymers whose mechanical resistance to abrasion is improved by the integration of organic (SiC) and mineral (Al₂O₃) fillers into the primer and finishing layers of the coating.

The performance gain achieved with regard to mechanical strength is satisfactory but still not optimal.

Fluoropolymer-based coatings are intended, in the first place, for frying pans and saucepans, but other applications can be envisaged in the field of molding (molds, cake dishes, waffle makers, etc.) or small domestic equipment (rice cookers, fryer tanks, electric crepe makers) because of their stampability.

An alternative to PTFE coatings is to use so-called “ceramic” coatings, developed via the sol-gel method and the use of tetraethyl orthosilicate (EP 2806776 B1). These coatings have the specific feature of being hard and resistant to mechanical wear but have a brittle behavior and are less non-stick compared to coatings based on fluoropolymers.

In addition, these coatings are not well suited to molding and small domestic equipment because of their lack of stampability.

In the field of molding (consumer or industrial), fluoropolymer-based coatings are not as widespread because the temperature resistance constraints are lower (max 220° C.) and allow the use of other types of coatings, such as silicone.

Pure silicone resins are described as non-stick and resistant to temperatures above 220-230° C. In return, they are considered to have poor adherence to the substrate.

Conversely, silicone-polyester resins are very widespread in the molding industry because they are non-stick while being adherent to the substrate and compatible with stamping processes. However, they degrade at temperatures above 230° C. In fact, the temperature range of use for culinary items is between 5° and 250° C. and it is not unusual to reach temperatures of 300° C. or even 350° C. in the case of items with induction bottoms. Their use is therefore not compatible with the temperatures of use in the field of culinary items.

### SUMMARY OF THE INVENTION

A first object of the invention concerns a coated cooking element (1) for a culinary item or electric cooking appliance, comprising a metal substrate (2) coated on at least one face (2a) by a single layer (3) in contact via one of its faces (3a) with the metal substrate (2) and one of its faces (3b) forming a cooking face (5), which layer (3) is composed of one or more silicone resins, of one or more heterocyclic thermoplastic polymers chosen from the group composed of polyetherimides (PEI), polyimides (PI), polyamide-imides (PAI) and polybenzimidazole (PBI), and optionally one or more aromatic thermoplastic polymers, one or more fillers and/or one or more additives and/or one or more coloring agents.

Another object of the invention concerns a method of manufacturing a coated cooking element (1) according to the invention, comprising the following successive steps:
i. Supplying a metal substrate (2) having a face (2a);
ii. Optionally, pre-treating the face (2a) of said metal substrate (2) intended to be coated;
iii. Applying the layer (3) on its face (2a).

Another object of the invention concerns a culinary item (100) comprising a coated cooking element (1) according to the invention.

Another object of the invention concerns an electric cooking appliance (200) comprising a coated cooking element (1) according to the invention and a heating source (210) configured to heat the coated cooking element (1).

### Definitions

The term “layer” or “coating” should be understood to mean, for the purposes of the present invention, a continuous or discontinuous layer. A continuous layer (also called a monolithic layer) is a single whole forming a total solid block completely covering the surface on which it is laid. A discontinuous layer (or non-monolithic layer) may comprise several parts, thus is not a single whole.

For the purposes of the present invention “thermochromic pigment or pigmentary composition” should be understood to mean a pigment or pigmentary composition that changes color as a function of temperature in a given temperature range, this change being reversible. This color change is visible to the user with the naked eye and at a conventional distance for use.

The term “thermostable pigment” is understood to mean a pigment which does not show a color change when subjected to a temperature increase in a given temperature range or which shows a color change when subjected to a temperature increase in a given temperature range so low that it is not visible to the user with the naked eye and at a conventional distance for use.

Preferably, thermostable pigments have a color difference ΔE* between 25° C. and 200° C. of less than 10, ΔE* being defined by the CIE1976 formula in the CIELAB color space:

$$Δ {E}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

L₁*, a₁* and b₁* characterizing the L*a*b values of said compound at room temperature
L₂*, a₂* and b₂* characterizing the L*a*b values of said compound at 200° C.

For the purposes of the present invention, the expression “culinary item” should be understood to mean an object intended for cooking. For this purpose, it is intended to receive a heat treatment.

The expression “object intended to receive a heat treatment” should be understood to mean, for the purposes of the present invention, an object which will be heated by an external heating system such as frying pans, saucepans, sauté pans, woks and barbecue grills and which is capable of transmitting the heat energy supplied by this external heating system to a material or food in contact with said object.

The expression “electric cooking appliance” should be understood to mean, for the purposes of the present invention, a heating object possessing its own heating system, such as an electric crepe maker, an electric raclette appliance, an electric fondue appliance, an electric grill, an electric griddle, an electric cooker, a bread maker and an electric pressure cooker.

“Coating” is understood to mean the layer covering the metal substrate and adhering to this substrate.

“Silicone resin-based coating” is understood to mean a coating which comprises one or more silicone resins in its layer. The coating according to the invention obtained is advantageously solid. “Solid” is understood to mean the characteristic of a cohesive material insoluble in water, in the usual solvents, in food components such as aqueous or fatty mixtures, even if the material may be very hard or very flexible, such as an elastomer.

In the present invention, the % by weight values are expressed as dry weight, i.e., without solvent.

### FIGURES

FIG. 1: Diagram of an cooking element according to the invention

FIG. 2: Diagram of a culinary item according to the invention

FIG. 3: Diagram of an electric cooking appliance according to the invention

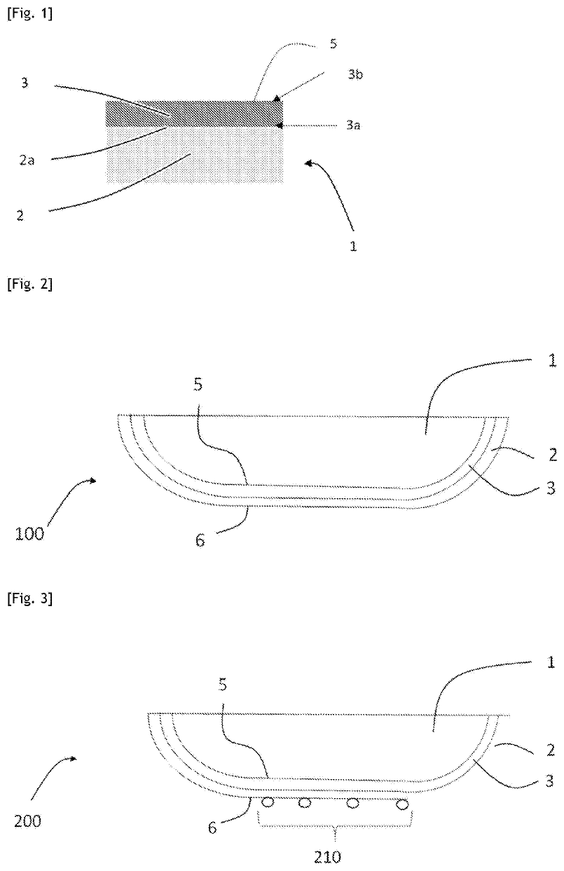

### DETAILED DESCRIPTION OF THE INVENTION

The invention concerns a coated cooking element (1) for a culinary item or electric cooking appliance, comprising a metal substrate (2) coated on at least one face (2a) with a single layer (3) in contact via one of its faces (3a) with the metal substrate (2) and one of its faces (3b) forming the cooking face (5), said layer (3) composed of one or more silicone resins, of one or more heterocyclic thermoplastic polymers chosen from the group composed of polyetherimides (PEI), polyimides (PI), polyamide-imides (PAI) and polybenzimidazole (PBI), and, optionally, one or more aromatic thermoplastic polymers, one or more fillers and/or one or more additives and/or one or more coloring agents.

Advantageously, the single layer (3) in contact via one of its faces (3a) with the metal substrate (2) is in the form of a single layer or a monolayer.

Advantageously, the single layer (3) forms a coating which coats the metal substrate (2). This coating has non-stick properties and forms a non-stick coating.

Advantageously, the single layer (3) in contact via one of its faces (3a) with the metal substrate (2) constitutes the coating of the cooking element, also called a monolayer coating.

The at least one coated face (2a) is therefore a cooking surface. In other words, the coating of the cooking element (1) according to the invention is intended to be in contact with food. The single layer (3) is in contact with food by one of its faces (3b), thereby forming a cooking face (5).

The coating of the cooking element (1) according to the invention does not comprise a fluoropolymer. In other words, said coating is devoid of fluorinated polymers.

Advantageously, the thickness of the layer (3) is comprised between 10 μm and 100 μm, preferably between 20 μm and 85 μm, particularly preferably between 30 μm and 70 μm.

### Metal Substrate

Advantageously, said metal substrate (2), is a substrate made of aluminum, stainless-steel, cast iron or cast aluminum, iron, titanium or copper.

For the purposes of the present invention, aluminum is understood to mean a metal composed of 100% aluminum or an aluminum alloy.

Advantageously, the metal substrate (2) is an aluminum substrate, stainless-steel substrate or a multilayer metal substrate. The metal substrate (2) may be a two-layer or three-layer substrate, these multilayer(s) being obtainable, for example, by colamination, by solid state bonding, or by hot or cold impact bonding.

Preferably, the metal substrate (2) comprises alternating layers of metal and/or metal alloy.

According to one embodiment, the metal substrate (2) is an aluminum alloy substrate, stainless-steel substrate, or a multilayer metal substrate having an aluminum alloy or stainless-steel face (2a).

Preferably, the metal substrate (2) is an aluminum substrate.

Advantageously, the thickness of the metal substrate (2) is comprised between 0.5 mm and 10 mm.

Advantageously, the face (2a) of the metal substrate (2) has previously undergone a surface treatment making it possible to improve the adhesion of the coating to said substrate.

According to one embodiment, the surface of the face (2a) of the metal substrate (2) has undergone a surface treatment, said surface treatment being chemical etching, brushing, hydration, sandblasting, shot blasting, physicochemical treatment of the plasma or corona or laser type, chemical activation or a combination of these different techniques.

Advantageously, the face (2a) of the substrate to which the coating (3) according to the invention will be applied can be treated so as to increase its specific surface; for an aluminum substrate, this treatment can be carried out by anodizing (creation of a tubular alumina structure), by chemical etching, by sandblasting, by brushing, by shot blasting or by adding material by means of a technology such as thermal spraying (flame, plasma or arc spraying). The other metal substrates can also be polished, sandblasted, brushed, microbead-blasted or receive added material by means of a technology such as thermal spraying (flame, plasma or arc spraying).

Metal substrates that can be used in the present invention advantageously include anodized or non-anodized aluminum substrates, optionally polished, brushed, sandblasted, shot-blasted or microbead-blasted, anodized or non-anodized aluminum alloy substrates, optionally polished, brushed, sandblasted or microbead blasted, steel substrates, optionally polished, brushed, sandblasted, shot-blasted or microbead-blasted, stainless-steel substrates, optionally polished, brushed, sandblasted or microbead-blasted, cast steel, aluminum or iron substrates, copper substrates, optionally hammered or polished.

Advantageously, the substrate may be chosen from substrates comprising ferritic stainless-steel/aluminum/austenitic stainless-steel layers, substrates comprising stainless-steel/aluminum/copper/aluminum/austenitic stainless-steel layers, shells made of cast aluminum, aluminum or aluminum alloys lined with an outer stainless-steel bottom, metal colaminated substrates, for example two-layer colaminated substrates comprising a stainless-steel layer (for example intended to constitute the inner face of the item) and an anodized or non-anodized layer of aluminum or aluminum alloy, intended to constitute the outer face of the item).

Advantageously, the arithmetic mean roughness Ra of the surface of the face (2a) of the metal substrate (2) is greater than or equal to 1 μm.

The arithmetic mean roughness Ra is measured using a roughness meter according to ISO 4287. Ra is the arithmetic mean of the deviations from the mean. The surface topography can especially be studied using a profilometer with a probe provided with a fine stylus equipped with a diamond tip, or with an optical metrology apparatus like Altisurf®, in which a confocal chromatic sensor allows a contactless measurement. The study of this surface topography makes it possible to define the mean arithmetic roughness Ra.

### Silicone Resins

In the text of the description, the expression “silicone resin” is used interchangeably to denote silicone before or after its crosslinking. In the text of the description, the expression “silicone” designates an organopolysiloxane material. Crosslinking is the step that converts silicone into an insoluble material, for example by polyaddition, polycondensation or dehydrogenation. The crosslinking is carried out using precursors that are generally silicone oils or resins, which crosslink in order to obtain a three-dimensional network forming a material called silicone resin in the description.

This crosslinking can be done by thermal activation, or chemical activation using a catalyst, such as, for example, platinum.

The silicone resins may be obtained from precursors, advantageously soluble in a solvent or in emulsion in water, such as crosslinkable oils or resins, especially chosen from: a silicone hydride, a silicone oil resin comprising at least one vinyl group (—CH═CH₂), a silicone resin or silicone-polyester resin (copolymer) comprising at least one alkoxy group, for example methoxy or ethoxy, and/or a silicone or silicone-polyester resin (copolymer) comprising at least one alkoxy group, in particular ethoxy, or a hydroxy group, and mixtures thereof. These precursors have the ability to crosslink in order to obtain a silicone resin that is characterized by its insolubility and its substantially solid form.

Advantageously, these precursors are polymeric or oligomeric, either in the form of silicone oils of variable degree of branching, or in the form of silicone resins of variable degree of pre-crosslinking or copolymers of silicone resins such as silicone-polyester, silicone-alkyds, silicone-polyurethanes or silicone-epoxy resins, or in the form of a mixture of silicone oils, silicone resins and copolymers of silicone resins. The silicon atoms may be substituted by alkyl (in particular methyl) or aryl (in particular phenyl) groups or mixtures thereof. The oils or resins preferably contain one or more (2, 3 or more) hydroxy or alkoxy functional groups (in particular methoxy, ethoxy, butoxy) as substituents of silicon atoms.

Advantageously, the silicone resin(s), obtained after crosslinking of their precursors, i.e. crosslinked, is (are) chosen from the group composed of methyl silicone resins and/or phenyl silicone resins and/or methyl phenyl silicone resins, methyl silicone-polyester resin (copolymers), phenyl silicone-polyester resin (copolymers), methyl phenyl silicone-polyester resin (copolymers), silicone-alkyd resin (copolymers), modified silicone resin and mixtures thereof.

Advantageously, the silicone resin(s) is (are) chosen from the group composed of methyl silicone resins and/or phenyl silicone resins and/or methyl phenyl silicone resins, methyl silicone-polyester resin (copolymers), phenyl silicone-polyester resin (copolymers), methyl phenyl silicone-polyester resin (copolymers), silicone-alkyd resin (copolymers), modified silicone resin and mixtures thereof.

The silicone resin of the single layer (3) forms a network which may be composed of a combination of 4 simple organosiloxane units denoted M, D, T and Q depending on the degree of substitution by oxygen of the silicon atom, as described in the following table, where R is an organic substituent described below.

| | Degree of substitution | |
|---|---|---|
| Structure | with oxygen | Symbol |
| R₃Si—O— | 1 | M |
| 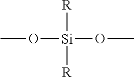 | 2 | D |
| 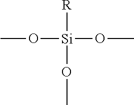 | 3 | T |
| 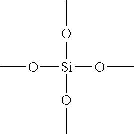 | 4 | Q |

The organopolysiloxane material or polymer is obtained by crosslinking from precursors which may be monomeric or polymeric, or intermediately which may be oligomeric. The organopolysiloxane polymer can also be obtained from a mixture of these different kinds of precursors. When the network contains a higher number of T and Q units than D, the crosslinking density is higher. The distribution between the M, D, T and Q units depends on the chemical structure of the precursors, in particular on this distribution M, D, T, Q within the precursors.

The polymeric precursors are organopolysiloxanes. These macromolecules are formed of M, D, T, and/or Q units as described in the table, where R is independently an alkyl group, in particular methyl, or aryl, in particular phenyl, it being possible for different types of R to be present on the same macromolecule.

The organopolysiloxanes may be either linear or slightly branched (majority of D groups) or branched or highly branched (majority of T and Q groups). Linear or slightly branched organopolysiloxanes are generally liquid, more or less viscous at room temperature, and are called silicone oils. Branched or highly branched (pre-crosslinked) organopolysiloxanes form a network at the scale of the individual macromolecule and are called silicone resins. At room temperature, the resins are substantially in solid form, or in liquid form, provided in particular that they have a fairly low molecular mass, in the form of a solution in a solvent or in the form of an aqueous emulsion. They may be copolymerized with organic polymers or oligomers not containing silicon, chosen in particular from polyesters, acrylics, alkyds, polyurethanes and epoxy resins.

When crosslinking is hydrolysis-polycondensation, it is carried out by means of the reactive hydroxy or alkoxy functions, in particular methoxy, ethoxy or butoxy, present on the organopolysiloxane.

When the crosslinking is a polyaddition (or hydrosilylation), it is carried out by reaction between the vinyl reactive functions (—CH═CH₂) present on one of the organopolysiloxanes and the silyl hydride (Si—H) reactive functions present on the other organopolysiloxane mixed with the first.

All these reactive functions are present on each organopolysiloxane, at least one in number, and can be present in number of 2, 3, or more as far as the molecular structure allows. Silicone oils containing at least one reactive function are called “reactive oils”. Reactive functions can be either at the end of a macromolecular chain (termination) or distributed over the chain.

Silicone-polyester resins in particular have silicone/polyester mass ratios, for example 90/10, 80/20, 70/30, 60/40, 50/50, 40/50, 30/70, 20/80, 10/90, advantageously between 80/20 and 50/50.

Linear PDMS silicone oils, pure or pre-emulsified in water, are characterized in the first place by their molecular mass, a direct increasing function of the viscosity of the pure oil. They are then characterized by the presence or absence of reactive functions, for example hydroxyl functions on the silicon atoms (silanol), their number and their location on the molecular chain. For example, reactive oils with viscosity comprised between 50 and 20,000 MPa·s, and in particular between 300 and 5,000 MPa·s, may be used, possessing at least one reactive function, preferentially at least 2, which may be placed at the end of the chain.

The polymer precursors reacting by polyaddition may include, for example, polymethylhydrosiloxane, vinylmethylsiloxane, vinyl terminated polydimethylsiloxane (PDMS), in particular linear, vinyl-terminated diphenylsiloxane-dimethylsiloxane copolymers, hydride terminated polydimethylsiloxanes, hydride terminated polyphenyl methylsiloxanes, cyclic vinylmethylsiloxane, vinyl-MQ resin, trimethylsilyl terminated polymethylhydrosiloxane, methylhydrosiloxane and trimethylsiloxane terminated dimethylsiloxane copolymer, MQ resin hydride, and the like, as well as combinations thereof.

Polymeric precursors reacting by hydrolysis-polycondensation, whether silicone resins or silicone oils, can include for example poly(methylsilsesquioxanes), poly(propylsilsesquioxanes), poly(phenylsilsesquioxanes), polydimethylsiloxane (PDMS), trimethylsilyl terminated polydimethylsiloxane (PDMS), hydroxyl terminated polydimethylsiloxane (PDMS), silanol terminated polydimethylsiloxane (PDMS), silanol terminated polyphenylsiloxane (PDMS), silanol terminated diphenylsiloxane-dimethylsiloxane copolymer, poly(2-acetoxyethylsilsesquioxanes), organo-modified alkoxy-silanes and their oligomers, and all similar macromolecules as well as mixtures thereof.

The organopolysiloxane material or polymer can also be obtained by crosslinking a mixture of one or more monomeric precursors and one or more polymeric precursors as described above, as well as one or more oligomeric precursors which may be linear, branched or cyclic. These oligomeric precursors have a lower molecular weight than the polymeric precursors. Polymeric and/or oligomeric precursors containing a number of reactive functional groups as described above greater than 2, advantageously much greater than 2, can be added to the mixture as a “co-binder” in order to promote a high crosslinking density of the organopolysiloxane polymer finally obtained.

Monomeric, oligomeric and/or polymeric precursors, in particular silicone resins, copolymerized with an organic polymer or not, play the role of polymeric binder in order to obtain the solid organopolysiloxane polymer combined with the thermoplastics of each layer.

Silicone oil-type organopolysiloxane precursors can be considered additives if they are added in a small quantity (usually between 0.1 and 5% dry) to the entire formula of a layer, independently of the other components for the formation of the solid organopolysiloxane polymer.

Crosslinking may require a catalyst:
In the case of crosslinking of organopolysiloxanes by hydrolysis-polycondensation, the formula may include a metal catalyst, such as metal complexes based on platinum, tin, zinc, zirconium and cerium, in particular platinum-cyclovinylmethyl-siloxane complexes, tin ethylhexanoate, zinc ethylhexanoate, zirconium ethylhexanoate, cerium ethylhexanoate and tin dibutyl laurate.
In the case of crosslinking organopolysiloxanes by hydrosilylation, the addition of a catalyst may be necessary: This may be, for example, platinum or a suitable platinum-based catalyst such as Karstedt catalyst or Ashbys catalyst.

A crosslinking agent, for example bearing Si—H bonds, may be present.

According to one embodiment, the proportion of silicone resin in the single layer (3) is greater than or equal to 20% by weight with regard to the total weight of the layer (3), respectively.

According to another embodiment, the proportion of silicone resin in the single layer (3) is greater than or equal to 40% by weight with regard to the total weight of the layer (3), respectively.

According to yet another embodiment, the proportion of silicone resin in the single layer (3) is greater than or equal to 50% by weight with regard to the total weight of the layer (3), respectively.

### Heterocyclic Thermoplastic Polymers

One or more heterocyclic thermoplastic polymers chosen from the group composed of polyetherimides (PEI), polyimides (PI), polyamide-imides (PAI) and polybenzimidazole (PBI) or mixtures thereof are present in the layer (3).

Advantageously, it (they) represents (represent) up to 99% by weight of the layer (3), preferably between 40 and 80%, advantageously between 40 and 70%, more advantageously still between 42 and 65%, particularly preferably between 45 and 55% by weight of the layer (3).

### Aromatic Thermoplastic Polymers

Suitable examples of aromatic thermoplastic polymer(s) according to the invention include poly(phenylene oxide) (PPO), poly(arylethersulfone) polymers (PAES), and, in particular, polyethersulfone (PES), polyphenylene ether sulfone (PPSU), poly(arylene sulfides) (PAS) and, in particular, polyphenylene sulfide (PPS), liquid crystal polymers and mixtures thereof.

Advantageously, the thermoplastic polymer(s) is (are) chosen from the group composed of poly(arylethersulfones) (PAES), polyethersulfone (PES), polyphenylene ether sulfone (PPSU), poly(arylene sulfide) (PAS), liquid crystal polymers (LCP), poly(phenylene oxide) (PPO), polyphenylene sulfide (PPS), polyaryletherketone (PAEK), including polyetherketone (PEK), polyetheretherketone (PEEK), polyetherketoneketone (PEKK), polyetheretherketoneketone (PEEKK) and polyetherketoneetherketoneketone (PEKEKK) and mixtures thereof.

Advantageously, the single layer (3) comprises one or more thermoplastic polymers, preferably in a proportion by weight of said layer of less than 50%, preferably less than 40%.

According to one variant, PAEK is used in the form of a suspension and the PAEK particles in the PAEK suspensions have a particle size with a D50 of approximately 10 μm to 15 μm.

### Fillers

Fillers for the purposes of the invention make it possible to provide mechanical reinforcement and can also provide hydrophobicity properties, while improving the mechanical strength and thermal conductivity of the coating.

Fillers do not have the sole function of providing color to the coating but can contribute to it.

The presence of fillers with excellent thermal conductivity makes it possible to compensate for the low thermal conductivity of PAEK polymers.

Advantageously, the layer (3) comprises one or more fillers chosen from the group composed of ceramic fillers (SiO₂, etc.) and/or mineral and/or metallic fillers (Al₂O₃, TiO₂, etc.) and/or silicas and/or diamond particles.

Preferentially, the filler(s) is (are) chosen from the group composed of metal oxides, metal carbides, metal oxynitrides, metal nitrides, and mixtures thereof.

Advantageously, said metal is a transition metal, such as at least one of the elements chosen from B, Ni, Ti, Zr or Hf.

More preferably, the filler(s) is (are) chosen from the group composed of:
reinforcing fillers: organic or inorganic hard fillers; inorganic hard fillers are preferably particles of silicon carbides or alumina or zirconia or graphite, or ceramics, or carbonate, or alumina hydrate, aluminum trihydroxide or one or more metal oxides, graphite, graphene;
other reinforcing fillers chosen from metal oxides: silica, micas, lamellar fillers, clays such as montmorillonite, sepiolite, gypsite, kaolinite and laponite, zinc dioxide, quartz, and zirconium phosphate, alumina, zirconia, zinc oxide, copper oxide, iron oxide;
fillers chosen from reinforcing fibers: glass or carbon or aramid fiber;
conductive fillers comprising a transition metal carbide and/or a transition metal nitride, characterized in that the transition metal is at least one of the elements chosen from B, Ni, Ti, Zr or Hf, for example: Cubic boron nitride, diamond particles, metal particles;
lamellar fillers that can confer lubricating properties, such as clays, graphene or graphite.

Preferred fillers in combination with organopolysiloxanes are:
reinforcing fillers: silica or carbonates with filler contents of min 10-15% by weight and up to 60% by weight;
alumina, alumina hydrate, aluminum trihydroxide;
silica (precipitated or pyrogenic) with a D50<0.1 μm and a BET specific surface area>30 m²/g and preferably comprised between 30 and 500 m²/g;
or mixture of quartz and silica, diatomaceous earths or ground quartz, titanium, mica, talc, kaolin, barium sulfate, slaked lime, zinc oxide, expanded vermiculite, unexpanded vermiculite, calcium carbonate, etc.

More preferably, the filler(s) is (are) chosen from the group composed of alumina, silicon carbide, tungsten carbide, boron nitride, quartz, and mixtures thereof.

Advantageously, the mean diameter D50 of the fillers is comprised between 0.1 and 50 μm, more advantageously between 5 and 15 μm.

Advantageously, the proportion of fillers in a layer is comprised between 0.5 and 30% by dry weight with regard to the total weight of said layer after curing, preferably between 5 and 20%.

Advantageously, the proportion of fillers in the layer (3) is less than 10% by weight with regard to the total weight of said layer.

### Additives

Advantageously, said additives are chosen from the group composed of antifoaming agents, dispersing agents, wetting agents, thickeners, pH adjusters and reactive silicone oils.

The said antifoaming agent(s) is (are) preferentially chosen from the group composed of mineral oils, diols, hydrocarbons, glycerides, oxirane and emulsified fatty acids.

The surfactant(s) is (are) preferentially chosen from the group composed of glycol ether, ethoxylated alcohol with the exclusion of alkyl phenol ethoxylates (APE), and Gemini surfactants.

The dispersing agent(s) is (are) preferentially chosen from the group composed of anionic dispersants such as fatty acid derivatives.

The said thickeners are preferentially chosen from the group composed of acrylic-based or polyurethane-based copolymer, cellulose and pyrogenic silica.

The said pH adjusters are preferentially chosen from the group composed of Bronsted bases: ammonia, amines (triethylamine, triethanolamine, etc.), hydroxides (sodium hydroxide, potassium hydroxide, etc.), carbonates.

Advantageously, the layer (3) comprises one or more additives and the proportion of additives in the layer (3) is less than 20% by weight with regard to the total weight of said layer.

### Coloring Agents

Advantageously, the coloring agent(s) is (are) chosen from the group composed of thermochromic pigments, thermostable pigments, flakes and mixtures thereof.

### Thermochromic Pigments

Preferably, the thermochromic pigment(s) is (are) chosen from the group composed of Bi₂O₃, Fe₂O₃, V₂O₅, WO₃, CeO₂, In₂O₃, Y_{1.84}Ca_{0.16}Ti_{1.84} V_{0.16}O_{1.84}, AgI, (Bi₁₋ₓAₓ) (V_{1-y}M_{y}) O₄ where
x is equal to 0 or x is comprised between 0.001 and 0.999;
y is equal to 0 or is comprised between 0.001 to 0.999;
A and M are chosen from the group composed of nitrogen, phosphorus, an alkali metal, an alkaline earth metal, a transition metal, a poor metal, a metalloid or a lanthanide;
A and M are different from each other.

Given that A and M are different from each other, when:
A is an alkali metal, it can be chosen from Li, Na, K, Rb and Cs;
M is an alkali metal, it can be chosen from Li, Na, K, Rb and Cs;
A is an alkaline earth metal, it can be chosen from Be, Mg, Ca, Sr and Ba;
M is an alkaline earth metal, it can be chosen from Be, Mg, Ca, Sr and Ba;
A is a transition metal, it can be chosen from Sc, Ti Cr, Mn, Fe, Co, Ni, Cu, Y, Zr, Nb, Mo, Ru, Rh, Pd, Ag, Ta, W and Ir;
M is a transition metal, it can be chosen from Sc, Ti Cr, Mn, Fe, Co, Ni, Cu, Y, Zr, Nb, Mo, Ru, Rh, Pd, Ag, Ta, W and Ir;
A is a poor metal, it can be chosen from Al, Zn, Ga, In and Sn;
M is a poor metal, it can be chosen from Al, Zn, Ga, In and Sn;
A is a metalloid, it can be chosen from B, Si, Ge and Sb;
M is a metalloid, it can be chosen from B, Si, Ge and Sb;
A is a lanthanide, it can be chosen from La, Ce, Pr, Nd, Pm, Sm, Eu, Gd, Tb, Dy, Ho, Er, Tm, Yb and Lu;
M is a lanthanide, it can be chosen from La, Ce, Pr, Nd, Pm, Sm, Eu, Gd, Tb, Dy, Ho, Er, Tm, Yb and Lu.

Preferably, A and M different from each other are B and/or Mg.

Preferably, the pigment (Bi₁₋ₓAₓ) (V_{1-y}M_{y}) O₄ has a monoclinic scheelite crystallographic form at room temperature.

Preferably, x and y are equal to 0, i.e., the pigment (Bi₁₋ₓAₓ) (V_{1-y}M_{y}) O₄ is bismuth vanadate (BiVO₄). Advantageously, a BiVO₄ of monoclinic scheelite crystallographic structure at room temperature is used.

Bismuth vanadate is a yellow inorganic compound of formula BiVO₄, widely used for its coloring properties and for its absence of toxicity. Recorded in the Colour Index International database as Q. I. Pigment Yellow 184, it is especially sold by the companies Heubach (Vanadur®), BASF (Sicopal®), FERRO (Lysopac) or Bruchsaler Farbenfabrik (Brufasol®).

### Thermostable Pigments

Preferably, the thermostable pigment(s) is (are) chosen from the group composed of:
Yellow pigment of the rutile titanium type;
Yellow pigment derived from bismuth, for example selected from stabilized bismuth vanadates (Py₁₈₄);
Red pigment, for example selected from perylene red (for example, PR149, PR178 and PR224), iron oxide;
Orange pigment of the bismuth oxyhalides type (PO₈₅);
Bismuth vanadate orange pigment (PO₈₆);
Zinc tin titanium orange pigment (PO₈₂);
Cerium sulfide orange pigment (PO₇₅; PO₇₈);
Antimony titanium chromium orange-yellow pigment of the rutile type (PBr₂₄);
Tin and zinc orange yellow pigment of the rutile type (Py₂₁₆);
Orange-yellow niobium oxide sulfide tin zinc pigment (Py₂₂₇);
Double tin and niobium oxide orange yellow pigment;
Co₃(PO₄)₂;
LiCoPO₄;
CoAl₂O₄;
Cr₂O₃;
TiO₂;
Black pigment PBk28 (copper chromite black spinel);
and mixtures thereof.

### Flakes

The flakes that can be used in the context of the present invention can be independently chosen from coated or uncoated mica flakes, coated or uncoated silica flakes, coated or uncoated aluminum flakes and coated or uncoated iron oxide flakes. Titanium dioxide coated mica or silica flakes. The flakes which can be used in the context of the present invention can be treated to give a particular color effect.

Advantageously, the flakes are particles chosen from the group composed of particles of mica, aluminum, mica coated with titanium dioxide or mixtures thereof.

### Holographic Flakes

Advantageously, the flakes are holographic flakes, that is to say a mixture of magnetizable particles and non-magnetizable particles.

The magnetizable particles may advantageously be particles comprising at least one ferromagnetic metal. These magnetizable particles may be of homogeneous nature, i.e., composed of the same material, or of composite nature, that is to say that these magnetizable particles have a core-shell structure, in which the ferromagnetic metal is located in the core and/or in the shell of said particles. Examples of composite magnetizable particles include mica flakes coated with iron oxide Fe₂O₃ or stainless-steel fibers coated with a sol-gel material, as protection against corrosion during the coating steps, or flakes made of plastic material coated with iron oxide Fe₂O₃, or flakes whose core is of ferromagnetic metal and whose shell is formed of a plastic material or of a sol-gel material.

According to one embodiment, a portion of said magnetizable particles is oriented so as to form a three-dimensional decoration.

Advantageously, the mixture of magnetizable particles and non-magnetizable particles represents between 1% and 5% by weight of the weight of the layer, preferably between 2% and 3% by weight.

Advantageously, the percentage of non-magnetizable particles in the mixture of magnetizable particles and non-magnetizable particles is comprised between 15% and 40% by weight with regard to the total weight of the mixture of magnetizable particles and non-magnetizable particles.

Advantageously, the magnetizable particles have a dimension D50 less than or equal to 23 μm.

The term “D50” is understood to mean, for the purposes of the present invention, the maximum dimension exhibited by 50% of the particles by weight.

Advantageously, the non-magnetizable particles have a dimension D90 comprised between 20% and 250% of the dimension D90 of the magnetizable particles.

The term “D90” is understood to mean, for the purposes of the present invention, the maximum dimension exhibited by 90% of the particles by weight.

Advantageously, the magnetizable particles and/or the non-magnetizable particles are colored on the surface.

Advantageously, the non-magnetizable particles are composed of mica, aluminum or mica coated with titanium dioxide.

Advantageously, the magnetizable particles are composed of iron, iron oxide, iron-coated aluminum or iron-coated mica, the iron being in ferritic form.

### Architecture

According to one embodiment of the invention, the layer (3) forming the coating comprises a single layer applied to the metal support or substrate to obtain a monolayer coating.

According to another embodiment of the invention, it is envisaged that the coating be produced by successive passes or applications of a layer of the same formulation, all in order to obtain a monolayer coating.

Advantageously, the coating according to the invention comprises one to three passes of the same layer, preferably two, applied to the substrate.

Advantageously, the coating according to the invention comprises intermediate layers, preferably two, which may be decorative layers.

Advantageously, the coating according to the invention is a coating compatible with cooking food.

Advantageously, the coating according to the invention is a monolayer coating.

### Decorations

According to one embodiment, the decoration layer(s) is (are) continuous and cover the entire single layer (3).

According to another embodiment, the decoration layer(s) are discontinuous and does (do) not cover the entire single layer (3) and forms (form) at least one decoration.

Advantageously, the decoration layer(s) are composed of several decorations, one (i) comprising one or more thermochromic pigments and the other (j) comprising at least one temperature reference pigmentary composition.

According to one embodiment, each of the two decorations (i) and (j) is in the form of adjacent non-overlapping patterns. For example, each decoration is represented by different geometric patterns uniformly distributed over the entire surface and alternating with regard to one another.

According to another embodiment, the two decorations (i) and (j) are partially overlapping. For example, each decoration is represented by different geometric patterns uniformly distributed over the entire surface and partially overlapping.

Preferably, the two decorations (i) and (j) are overlapping, either because one of the two decorations is a continuous layer and the other decoration covers it in the form of patterns, or because the two decorations (i) and (j) are in the form of overlapping patterns. In another embodiment, the decorations are applied directly to the metal substrate (2).

The decoration can be applied by any method well known to the person skilled in the art, for example by screen printing or pad printing.

### Method

The invention also concerns a method of manufacturing a coated cooking element (1) according to the invention comprising the following successive steps:
i. Supplying a metal substrate (2) having a face (2a);
ii. Optionally, pre-treating the face (2a) of said metal substrate (2) intended to be coated;
iii. Applying the layer (3) on the face (2a).

The layer (3) in step (iii) can be applied by electrostatic powder coating or by spraying in solvent or aqueous phase or by screen printing or roller printing or by digital printing.

The application of the coating according to the invention by the method according to the invention to the substrate makes it possible to obtain a thermostable coating layer.

Generally, this coating layer is wet. “Wet layer” is understood to mean, for the purposes of the present invention, that the layer comprises all or part of its solvents.

Preferably, all or part of the solvents of the wet layer are removed, either naturally or by a physical treatment, for example by thermal drying, by air flow drying or by vacuum treatment.

Advantageously, the coating composition according to the invention may also comprise at least one solvent. Advantageously, the solvent may be protic. Advantageously, the solvent may be non-toxic.

The solvent which can be used in the coating composition according to the invention may advantageously comprise at least one alcohol and may preferably be chosen from isopropanol, methanol, ethanol and mixtures thereof.

According to a variant of the method according to the invention, the coating can be applied in several layers. In this case, the deposition on at least one of the two opposite faces of said substrate of at least one coating composition according to the invention is repeated several times. Preferably, according to this variant, a drying step is carried out between the application of each layer, then said coated substrate is cured after application of the last layer.

The coating formula to be applied is generally in aqueous form, the polymers of the polymeric phase being in the form of suspensions. Other non-aqueous solvents may also be suitable.

Advantageously, the method for manufacturing a coated cooking element (1) according to the invention comprises one or more drying steps between 8° and 150° C. after application of each of the layers. Drying can be carried out by convection or infrared.

The coating according to the invention can be applied by the method according to the invention on the flat substrate or on the shaped substrate or on a locally flat area of the shaped substrate. A thermostable coating layer is obtained. Generally, this coating layer is wet.

Advantageously, the method of manufacturing a coated cooking element (1) according to the invention comprises a step of shaping said substrate (2) before or after step iii. or after step iv. of curing. Shaping is also called stamping.

When the shaping step precedes step iii. of applying the coating, the coating is preferentially carried out by spraying.

When this shaping step is subsequent to the step iii. of applying the coating, the coating is preferentially carried out by screen printing or by roller printing.

The method according to the invention advantageously comprises a step iv. of curing the element obtained in step iii. of the method. For the purposes of the present invention, curing of the coated substrate is understood to mean a heat treatment which makes it possible to densify the coating layer or layers applied to the substrate, but also to crosslink the organopolysiloxane precursors (silicone resin).

The invention also concerns a method of manufacturing a coated cooking element (1) according to the invention comprising the following successive steps:
i. Supplying a metal substrate (2) having a face (2a);
ii. Optionally, pre-treating the face (2a) of said metal substrate (2) intended to be coated;
iii. Applying the layer (3) onto the face (2a);
iv. Curing of the element obtained in step iii.

Curing is carried out in step iv. Generally, the curing temperature of step iv. is comprised between 230° C. and 420° C.

Advantageously, the method for manufacturing a coated cooking element (1) according to the invention comprises a single final curing step iv. of all the applied layers. This single curing step is carried out simultaneously for all the applied layers. This embodiment makes it possible to film, fuse and crosslink all the layers together so that they form one layer. The coating (3) thus forms a single layer, although this single layer may not be homogeneous, that is to say it may have a heterogeneity of composition such as, for example, a concentration gradient of its constituents.

### Item

The invention also concerns a culinary item (100) comprising a coated cooking element (1).

According to one embodiment, the culinary item (100) has a heating face (6) intended to be brought into contact with an external heating source, the heating face (6) being opposite the cooking face (5) intended to be brought into contact with the food during cooking.

Advantageously, the culinary item (100) according to the invention is chosen from the group composed of saucepan, frying pan, skillet or fondue pot, raclette, Dutch oven, wok, sauté pan, crepe maker, grill, griddle, marmite, cocotte, insert for an electric cooker or bread maker, or food mold.

The invention also concerns an electric cooking appliance (200) having a coated cooking element (1) according to the invention and a heating source (210) configured to heat the coated cooking element (1).

Advantageously, the electric cooking appliance (200) is chosen from the group composed of electric crepe maker, electric raclette appliance, electric fondue appliance, electric grill, electric griddle, electric cooker, bread maker, electric pressure cooker, waffle maker, rice cookers and jam makers.

The culinary item according to the present invention may especially be a culinary item in which one of the two opposite faces of the substrate is an inner face, optionally concave, intended to be disposed on the face where the food will be introduced into or onto said item, and in which the other face of the substrate is an outer face, optionally convex, intended to be disposed toward a heat source.

Non-limiting examples of culinary items in accordance with the present invention, especially include culinary items such as saucepans and frying pans, woks and sauté pans, Dutch ovens and marmites, crepe makers, baking molds and sheets, barbecue griddles and grills, food prep bowls.

### EXAMPLES

The aims, aspects and advantages of the present invention will be better understood from the description given below of a particular embodiment of the invention presented by way of non-limiting example.

Of course, the invention is in no way limited to the embodiment described and illustrated, which has been given only by way of example. Modifications remain possible, especially from the viewpoint of the constitution of the various elements or by substitution of technical equivalents, without thereby exceeding the scope of protection of the invention.

### 1) Raw Materials:

### Metal Substrate:

The aluminum discs are a 4006 alloy in the annealed state, with a thickness of 3.4 mm and a diameter of 340 mm. They have been treated by brushing (roughness Ra approximately 2 μm).

### Silicone Resins:

RS1: Ethoxy-functionalized methyl organopolysiloxane resin in aqueous emulsion, viscosity at 25° C. approx. Approx. 1500 mPas, Solids content=52%;
PDMS_1: Polydimethylsiloxane (PDMS) resin in aqueous emulsion Functionalized PDMS, Solid content 62%;

### Polyaryletherketone:

an aqueous dispersion of PEEK (polyetheretherketone) from VICTREX under the name VICOTE Coatings F804 “Vicote F804”: particle size D50=10 μm; dry extract 35%; pH between 9.6 and 11.9; viscosity approximately 11 sec DIN Cup #6.

### Aromatic Thermoplastic Polymers:

Polyamide-imide powder resin (PAI): TORLON AI10LS from Solvay, powder containing 90% dry extract in N-methylpyrrolidone (NMP/water);
Polyimide powder resin (PI): P84® NT from Evonik.

### Reinforcing Fillers:

Aerosil R972 (Evonik);
   Post-treated dimethyl dichlorosilane, fumed silica, specific surface area (BET)=90 to 130 m²/g;
LEVASIL CC301: colloidal silica in aqueous phase with a solids content of 30%;
Alumina: Alumina CAHPF 240 D50=45-50 μm of 100% Alteo.

### Pigments:

Sicopal black K0098FK (Sun Chemical): chromium/iron oxide powder: Index=P.BR.29.

### Alcohol Solvent

2-methoxy-1-methylethyl acetate (MPA);
Butyl glycol acetate (BGA);
Butyl acetate.

### Additives

Anti-foaming agent;
   Moussex 7114HL from Synthon.

### Other Additives:

Acrylic resin;
   MODAREZ SD15 from Synthon with a dry extract of 30% in aqueous phase.

### Working Principle of the Jar Mill (Mechanical Milling):

Ball milling consists of loading a jar with the sample to be milled and so-called milling balls and rotating the jar around its axis at a certain speed. The jar is usually rotated using a roller machine. The sample may be milled dry or dispersed in a suitable solvent (e.g., water or alcohol). The dispersion may also contain certain adjuvants (such as a dispersant or an antifoam).

The mean diameter of the milling balls must be adapted to the size of the particles to be milled. The finer the particles, the smaller the diameter of the balls to be used. The total volume of balls, including the voids between the balls, will represent approximately 50-60% of the internal volume of the jar. The balls of different sizes are advantageously distributed according to the following proportion by weight relative to the total weight of the balls: 25% small balls, 50% medium balls and 25% large balls. The size of the smallest balls is comprised between 2 and 10 mm. Alumina and stabilized zirconia are commonly used as the material of the balls.

### 2) Examples of Embodiment of a Culinary Item According to the Invention:

The coating is carried out flat on flat aluminum discs. The aluminum discs are a 4006 alloy in the annealed state, with a thickness of 3.4 mm and a diameter of 340 mm. They have been treated by brushing (roughness Ra approximately 2 μm).

A single continuous layer (3) according to the invention is deposited on this aluminum disk by screen printing, chosen from the layer compositions as described below (layers of Examples 1 to 3 according to the invention and layers of Counter-examples 1 and 2 outside the invention).

The coating by screen printing is done according to the following parameters:
between 1 and 4 application passes, preferably 2 or 3;
partial drying may be envisaged between each pass before coating the next;
the final curing is carried out in an oven between 23° and 420° C. for 10 to 30 minutes, then the discs are left to cool;
the thickness obtained is between 20 and 50 μm, preferably between 30 and 40 μm.

The coated discs are pressed to form frying pans with an internal diameter of 26 cm.

The aqueous composition of the single coating layer (3) is prepared according to the ball milling principle. Ball milling is carried out in a jar as described above. The sample may be milled dry or dispersed in a suitable solvent (e.g. water, alcohol or solvent). The dispersion may also contain certain adjuvants (such as a dispersant or an antifoam).

| | | | Fillers % in |
|---|---|---|---|
| | % solid phase | Heterocyclic | solid phase |
| | after curing in | thermoplastic/ | after curing |
| EXAMPLE 1 | the coating | Silicone resin | in coating |
| RS1 | 51.0%; | PAI/RS1: 45/55 | |
| PAI: TORLON Al10LS | 41.1%; | | |
| Aerosil R972 | 5.8%; | | Fillers: 6% |
| Sikkopal K0098FK | 1.5% | | |
| Moussex 7114HL | 0.7% | | |
| DRY BASE | 100.0% | | |

| | Wet mass (g) | Dry extract (%) |
|---|---|---|
| | Composition of | of the liquid |
| | the liquid | composition |
| RS1 | 42.5 | 52% |
| Aerosil R972 | 2.5 | |
| Butyl acetate (BA) | 1.7 | |
| Water | 32.6 | |
| Moussex 7114HL | 0.3 | |
| Sikkopal K0098FK | 0.6 | |
| TORLON Al10LS | 19.8 | 90% |
| TOTAL | 100.0 | 43% |

| | | | Fillers % in |
|---|---|---|---|
| | % solid phase | Heterocyclic | solid phase |
| | after curing in | thermoplastic/ | after curing |
| EXAMPLE 2 | the coating | Silicone resin | in coating |
| RS1 | 48.7% | PAI/(RS1 + | |
| PDMS_1 | 2.6% | PDMS_1): 44/56 | |
| PAI: TORLON Al10LS | 41.1% | | |
| Aerosil R972 | 4.7% | | Fillers: 5% |
| Sikkopal K0098FK | 2.3% | | |
| Moussex 7114HL | 0.6% | | |
| DRY BASE | 100.0% | | |

| | Wet mass (g) | Dry extract (%) |
|---|---|---|
| | Composition of | of the liquid |
| | the liquid | composition |
| RS1 | 40.6 | 52% |
| PDMS1 | 1.8 | 62% |
| Aerosil R972 | 2.0 | |
| Butyl acetate (BA) | 1.5 | |
| Water | 33.0 | |
| Moussex 7114HL | 0.3 | |
| Sikkopal K0098FK | 1.0 | |
| TORLON Al10LS | 19.8 | 90% |
| TOTAL | 100.0 | 43% |

| | | | Fillers % in |
|---|---|---|---|
| | % solid phase | Heterocyclic | solid phase |
| | after curing in | Thermoplastic/ | after curing |
| EXAMPLE 3 | the coating | Silicone resin | in coating |
| RS1 | 51.0% | PI/RS1: 44/56 | |
| PI: P84@NT | 41.1% | | |
| Aerosil R972 | 5.8% | | Fillers: 6% |
| Sikkopal K0098FK | 1.5% | | |
| Moussex 7114HL | 0.7% | | |
| DRY BASE | 100.0% | | |

| | Wet mass (g) | Dry extract (%) |
|---|---|---|
| | Composition of | of the liquid |
| | the liquid | composition |
| RS1 | 42.5 | 52% |
| Aerosil R972 | 2.5 | |
| Butyl acetate (BA) | 1.7 | |
| Water | 32.6 | |
| Moussex 7114HL | 0.3 | |
| Sikkopal K0098FK | 0.6 | |
| PI: P84@NT | 19.8 | 90% |
| TOTAL | 100.0 | 43% |

| | | | Fillers % in |
|---|---|---|---|
| | % solid phase | Heterocyclic | solid phase |
| COUNTER- | after curing in | Thermoplastic/ | after curing |
| EXAMPLE 1 | the coating | Silicone resin | in coating |
| RS1 | 18.3% | PEEK/RS1: 64/36 | |
| PEEK | 32.7% | | |
| Aerosil R972 | 23.4% | | Fillers: 47% |
| Alumina | 23.4% | | |
| Sikkopal K0098FK | 1.7% | | |
| Moussex 7114HL | 0.4% | | |
| DRY BASE | 100.0% | | |

| | Wet mass (g) | Dry extract (%) |
|---|---|---|
| | Composition of | of the liquid |
| | the liquid | composition |
| RS1 | 15.5 | 52% |
| Aerosil R972 | 10.3 | |
| Alumina CAHPF 240 | 10.3 | |
| Butyl acetate (BA) | 1.1 | |
| Water | 45.9 | |
| Moussex 7114HL | 0.2 | |
| Sikkopal K0098FK | 0.8 | |
| PEEK | 16.0 | 90% |
| TOTAL | 100.0 | 44% |

| | | | Fillers % in |
|---|---|---|---|
| | % solid phase | Heterocyclic | solid phase |
| COUNTER- | after curing in | thermoplastic/ | after curing |
| EXAMPLE 2 | the coating | Silicone resin | in coating |
| TORLON Al10LS | 80.6% | PAI: 100 | |
| Levasil CC301 | 9.3% | | Fillers: 9% |
| Sikkopal K0098FK | 2.4% | | |
| Modarez SD 15 | 7.7% | | |
| DRY BASE | 100.0% | | |

| | Wet mass (g) | Dry extract (%) |
|---|---|---|
| | Composition of | of the liquid |
| | the liquid | composition |
| Levasil CC301 | 9.5 | 30% |
| MPG | 9.5 | |
| Water | 45.2 | |
| Modarez SD 15 | 7.6 | 31% |
| Sikkopal K0098FK | 0.7 | |
| TORLON Al10LS | 27.4 | 90% |
| TOTAL | 100.0 | 31% |

### Method for Evaluating the Properties of the Non-Stick Coating: EGG PERFORMANCE TEST

The method for evaluating the properties of the non-stick coating is carried out using the egg test adapted from AFNOR NF D 21-511 paragraph 3.3.2, and implemented as follows:

The sample is cleaned, then the remaining water is wiped off the surface.

The inner surface of the container body is dried beforehand.

The cooking vessel is heated on a gas stove to a temperature comprised between 14° and 170° C.

A calibre [French size labeling] 60/65 egg is broken and poured centrally onto the hot cooking vessel and the egg is allowed to coagulate (6 to 9 minutes); the egg is removed from the cooking vessel with a spatula, the coating is cleaned with a damp plant-based sponge and the non-stick properties of the cooking vessel are evaluated through this action, then recorded:
Grade of 100: The egg can be removed entirely with a plastic spatula;
Grade of 75: The egg is not completely removed but the coating is easily cleaned with a damp sponge;
Grade of 50: The egg is not completely removed but the coating is cleanable with a damp sponge;
Grade of 25: The egg is not completely removed and the coating is not cleaned with a damp sponge;
Grade of 0: The egg is not removed and the coating cannot be cleaned with a damp sponge.

| Examples | Egg test |
|---|---|
| 1 | 100 |
| 2 | 100 |
| 3 | 100 |
| Counter-example 1 | 25 |
| Counter-example 2 | 0 |

1-15. (canceled)

16. A coated cooking element for a culinary item or electric cooking appliance, having a metal substrate coated on at least one face with a single layer in contact via one of its faces with the metal substrate and one of its faces forming the cooking face, which layer is composed of one or more silicone resins, of one or more heterocyclic thermoplastic polymers chosen from the group composed of polyetherimides (PEI), polyimides (PI), polyamide-imides (PAI) and polybenzimidazole (PBI), and, optionally, one or more aromatic thermoplastic polymers, one or more filler(s) and/or one or more additive(s) and/or one or more coloring agents.

17. The coated cooking element according to claim 16, wherein the silicone resin(s) is (are) chosen from the group composed of methyl silicone resins and/or phenyl silicone resins and/or methyl-phenyl-silicone resins, methyl phenyl silicone-polyester resin (copolymers), methyl silicone-polyester resin (copolymers), phenyl silicone-polyester resin (copolymers), silicone-alkyd resin (copolymers), modified silicone resin and mixtures thereof.

18. The coated cooking element according to claim 16, wherein the single layer comprises one or more fillers chosen from the group composed of ceramic and/or mineral and/or metallic fillers and/or silicas and/or diamond particles.

19. The coated cooking element according to claim 16, wherein the aromatic thermoplastic polymer(s) is (are) chosen from the group composed of poly(arylethersulfones) (PAES), polyethersulfone (PES), polyphenylene ether sulfone (PPSU), polyphenylene sulfide (PPS), liquid crystal polymers (LCP), poly(phenylene oxide) (PPO), poly(arylene sulfide) (PAS) polyaryletherketone (PAEK) including polyetherketone (PEK), polyetheretherether ketone (PEEK), polyetherketoneketone (PEKK), polyetheretherketoneketone (PEEKK) and polyetherketoneetherketoneketone (PEKEKK) and mixtures thereof.

20. The coated cooking element according to claim 16, wherein said metal substrate is an aluminum, stainless-steel, cast iron or cast aluminum, iron, titanium or copper substrate.

21. The coated cooking element according to claim 16, wherein the thickness of the layer is comprised between 10 μm and 100 μm.

22. The coated cooking element according to claim 21, wherein the thickness of the layer is comprised between 20 μm and 85 μm.

23. The coated cooking element according to claim 21, wherein the thickness of the layer is comprised between 30 and 70 μm.

24. The coated cooking element according to claim 16, wherein the proportion of silicone resin in the layer is greater than or equal to 30% by weight with regard to the total weight of the layer.

25. The coated cooking element according to claim 24, wherein the proportion of silicon resin in the layer is greater than or equal to 50% by weight with regard to the total weight of the layer.

26. The coated cooking element according to claim 16, wherein the proportion of fillers in the layer is less than 10% by weight with regard to the total weight of the layer.

27. The coated cooking element according to claim 16, wherein the layer comprises one or more additives and the proportion of additives in the layer is less than 20% by weight with regard to the total weight of the layer.

28. A method of manufacturing a coated cooking element according to claim 16, comprising the following successive steps:
i. Supplying a metal substrate having a face;
ii. Optionally, pre-treating the face of said metal substrate intended to be coated;
iii. Applying the layer on the face.

29. A culinary item comprising a coated cooking element according to claim 16.

30. The culinary item according to claim 29, further comprising a heating face intended to be brought into contact with an external heating source, the heating face being opposite the cooking face intended to be brought into contact with the food during cooking.

31. The culinary item according to claim 29, chosen from the group composed of saucepan, frying pan, skillet, fondue pot or raclette, Dutch oven, wok, sauté pan, crepe maker, grill, griddle, marmite, cocotte, cooker or bread maker insert, culinary mold.

32. An electric cooking appliance having a coated cooking element and a heating source configured to heat said coated cooking element, wherein said coated cooking element is according to claim 16.

33. The electric cooking appliance according to claim 32, chosen from the group composed of electric crepe maker, electric raclette appliance, electric fondue appliance, electric grill, electric griddle, electric cooker, bread maker, electric pressure cooker, waffle makers, rice cookers and jam makers.
